(19) United States
(12) Patent Application Publication
(10) Pub. No.: US 2014/0071914 A1
(43) Pub. Date: Mar. 13, 2014

(54) METHOD AND DEVICE FOR CONFIGURING SPATIAL DIVERSITY OF AN ENHANCED PHYSICAL DOWNLINK CONTROL CHANNEL

(71) Applicant: Samsung Electronics Co., Ltd., Suwon-si (KR)

(72) Inventors: Yingyang LI, Beijing (CN); Chengjun SUN, Beijing (CN)

(73) Assignee: Samsung Electronics Co., Ltd., Suwon-si (KR)

(21) Appl. No.: 14/018,721

(22) Filed: Sep. 5, 2013

(30) Foreign Application Priority Data
Sep. 7, 2012 (CN) 201210330696.5

(51) Int. Cl. H04L 5/00

(52) U.S. Cl. CPC H04L 5/0035
USPC 370/329

(57) ABSTRACT

A method for configuring spatial diversity of an enhanced Physical Downlink Control CHannel (ePDCCH) is provided. The method includes alternately using, by each Resource Element (RE) in an enhanced Resource Element Group (eREG), one of N_{AP} Antenna Ports (AP) by granularity of one RE, mapping each RE in a Physical Resource Block (PRB) pair to a fixed AP. The present disclosure further discloses a method for constructing a localized enhanced Control Channel Element (eCCE) and a method for constructing a distributed eCCE. The present disclosure further discloses devices respectively corresponding to above-mentioned methods. By use of the present disclosure, performance of spatial diversity of a distributed ePDCCH is improved and a number of the REs in the localized eCCE and the distributed eCCE are averaged to guarantee that link performance is uniform or close to each other.

### CROSS-REFERENCE TO RELATED APPLICATION(S)

This application claims the benefit under 35 U.S.C. §119(a) of a Chinese patent application filed on Sep. 7, 2012 in the Chinese Intellectual Property Office and assigned Serial No. 201210330696.5, the entire disclosure of which is hereby incorporated by reference.

### TECHNICAL FIELD

The present disclosure relates to wireless communication system. More particularly, the present disclosure relates to a method and system for configuring spatial diversity of an enhanced Physical Downlink Control CHannel (ePDCCH), a method and system for constructing a localized enhanced Control Channel Element (eCCE), and a method and system for constructing a distributed eCCE.

### BACKGROUND

In 3GPP LTE system, a length of each radio frame is 10 ms, which is divided into 10 subframes equally. A downlink Transmission Time Interval (TTI) is defined as a subframe. As shown in FIG. 1, each downlink subframe includes two time slots for a normal Cyclic Prefix (CP) length, each time slot includes 7 Orthogonal Frequency Division Multiple Access (OFDM) symbols for an extended CP length, and each time slot includes 6 OFDM symbols. In each subframe, the first n OFDM symbols, where n is equal to 1, 2 or 3, are used for transmitting downlink control information including a Physical Downlink Control CHannel (PDCCH) and other control information and the remaining OFDM symbols are used for transmitting a Physical Downlink Shared CHannel (PDSCH). Resource allocation granularity is a Physical Resource Block (PRB), and one PRB includes 12 consecutive sub-carriers in frequency in one time slot. Two PRBs in two time slots and on the same sub-carrier of one subframe is called as a PRB pair. In each PRB pair, each Resource Element (RE) which includes one sub-frame in the frequency and one OFDM symbol in the time is a minimum unit. The RE may be respectively used for different functionalities. For example, a part of the REs may be used for such as transmitting a Cell specific Reference Signal (CRS), a user specific DeModulation Reference Signal (DMRS), and a Channel Quality Indication Reference Signal (CSI-RS).

In a LTE enhancement version, in order to support lager control channel capacity and support interference collaboration among control channels of multiple cells, an enhanced PDCCH (ePDCCH) is provided. The ePDCCH is mapped into a data region of the subframe and transmitted by use of Frequency Division Multiplexing (FDM) with the PDSCH. A base station may notify a User Equipment (UE) of the PRB pair used for transmitting the ePDCCH by a high layer signal. Moreover, PRB pairs used for transmitting the ePDCCH may be different for different UEs.

FIG. 1 is a diagram illustrating a subframe structure according to the related art.

Referring to FIG. 1, for a frame structure of the normal CP length, there are 24 REs used for carrying reference signals of the ePDCCH. The 24 REs may multiplex 4 orthogonal antenna ports based on FDM/Code Division Multiplexing (CDM).

According to the current discussion, a concept of an ePDCCH set is provided. The base station may configure the UE to detect the ePDCCH in multiple ePDCCH sets. The ePDCCH set includes one or multiple PRB pairs. According to a method for mapping ePDCCH resource, the ePDCCH may include a localized ePDCCH and a distributed ePDCCH. Each ePDCCH set is used for carrying either the localized ePDCCH or the distributed ePDCCH. Each distributed ePDCCH is mapped to all of PRB pairs in the ePDCCH set, while each localized ePDCCH is mapped to one of the PRB pairs in the ePDCCH set. When an aggregation level of the localized ePDCCH is large, a localized ePDCCH is mapped to multiple PRB pairs in the ePDCCH set.

In order to multiplex multiple ePDCCHs in one PRB pair, all of REs of each PRB pair except the REs used for a DMRS (shown by grid in the figure) are divided as a RE group called an enhanced Resource Element Group (eREG).

FIG. 2 is a diagram illustrating division of enhanced Resource Element Groups (eREGs) in a Physical Resource Block (PRB) pair according to the related art.

Referring to FIG. 2, each PRB pair is divided into 16 eREGs. An index of each eREG is circularly mapped to the REs which may be used for the ePDCCH in one PRB pair in the order of the frequency first, and then the time. A Control Channel Element (CCE) obtained by a combination of multiple eREGs is called an enhanced CCE (eCCE). The time and frequency resource occupied by one ePDCCH is obtained by combination of multiple eCCEs.

According to the current discussion, for the distributed ePDCCH, link performance is improved by spatial diversity. Specifically, for one ePDCCH, each RE in one PRB pair alternately uses one of two Antenna Ports (APs), wherein granularity of mapping between the RE and the AP is one RE.

However, there is still no corresponding technical solution provided for how to provide the spatial diversity of the ePDCCH to reduce complexity that the UE demodulates the RE occupied by an ePDCCH candidate, and for full use of the spatial diversity to improve the link performance of the ePDCCH.

In addition, there is further no corresponding technical solution of how to construct the localized eCCE and distributed eCCE to balance link performance of the eCCEs.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and device for configuring spatial diversity of an enhanced Physical Downlink Control CHannel (ePDCCH) to reduce complexity that a User Equipment (UE) demodulates a Resource Element (RE) occupied by an ePDCCH candidate, and to fully use the spatial diversity for improving link performance of a distributed ePDCCH.

Another aspect of the present disclosure is to provide a method and device for constructing a localized enhanced Control Channel Element (eCCE) and a method and device for constructing a distributed eCCE to balance the link performance of each eCCE.

In accordance with an aspect of the present disclosure, a method for configuring spatial diversity of an ePDCCH is provided. The method includes alternately using, by each RE in an enhanced Resource Element Group (eREG), one of N_{AP} Antenna Ports (AP) by granularity of one RE, and mapping each RE in a Physical Resource Block (PRB) pair to a fixed AP.

In accordance with another aspect of the present disclosure, a method for constructing a localized eCCE is provided. The method includes dividing each PRB pair into N_{eREG} eREG, and constructing the localized eCCE by combination of eREGs according to a number of OFDM symbols occupied by a PDCCH, a number of Downlink Pilot Time Slots (DwPTS) symbols, and locations of channel quality indication Reference Signals (CSI-RS), such that a number of REs of the constructed eCCEs are equal or close to each other.

In accordance with another aspect of the present disclosure, a method for constructing a distributed eCCE is provided. The method includes dividing each PRB pair into N_{eREG} eREG, occupying, by each distributed eCCE,

$$\frac{M}{N}$$

eREGs in each PRB pair in an ePDCCH set and mapping each distributed eCCE to the eREGs with a different index in each PRB pair in the ePDCCH set, wherein M is a number of REs included in the distributed eCCE and N is a number of PRB pairs in the ePDCCH set.

In accordance with another aspect of the present disclosure, a device for configuring spatial diversity of an ePDCCH is provided. The device includes an alternate mapping module, wherein the alternate mapping module, is adapted to cause each RE of an eREG alternately use one of N_{AP} APs by a granularity of one to map each RE to a fixed AP in a PRB pair, and wherein N_{AP} is larger than or equal to 2.

In accordance with another aspect of the present disclosure, a device for constructing a localized eCCE is provided. The device includes a first dividing module and a constructing module, wherein the first dividing module is adapted to divide each PRB pair into N_{eREG} eREGs, and wherein the first constructing module is adapted to construct the localized eCCE by combination of the REGs according to a number of the OFDM symbols occupied by a PDCCH, a number of DwPTS symbols, and locations of CSI-RSs, such that a number of the REs of constructed localized eCCEs are equal or close to each other.

In accordance with another aspect of the present disclosure, a device for constructing a distributed eCCE is provided. The device includes a second dividing module and a second constructing module, wherein the second dividing module is adapted to divide each PRB pair into N_{eREG} eREGs, and wherein the second constructing module is adapted to cause each localized eCCE in an ePDCCH set occupy

$$\frac{M}{N}$$

eREGs and map each distributed eCCEs into a eREG with a different index in each PRB pair of the ePDCCH set, wherein M is a number of the REs included in the distributed eCCE and N is a number of the PRB pairs included in the ePDCCH set.

The method and device for configuring spatial diversity of an ePDCCH provided by the present disclosure can reduce complexity that a UE demodulates the RE occupied by an ePDCCH candidate, and improve link performance of a distributed ePDCCH. The method and device for constructing a localized eCCE and the method and device for constructing a distributed eCCE provided by the present disclosure can average the number of the REs in the localized eCCE and the distributed eCCE and, thus, guarantee the link performance is uniform or close to each other.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram illustrating a subframe structure according to the related art;

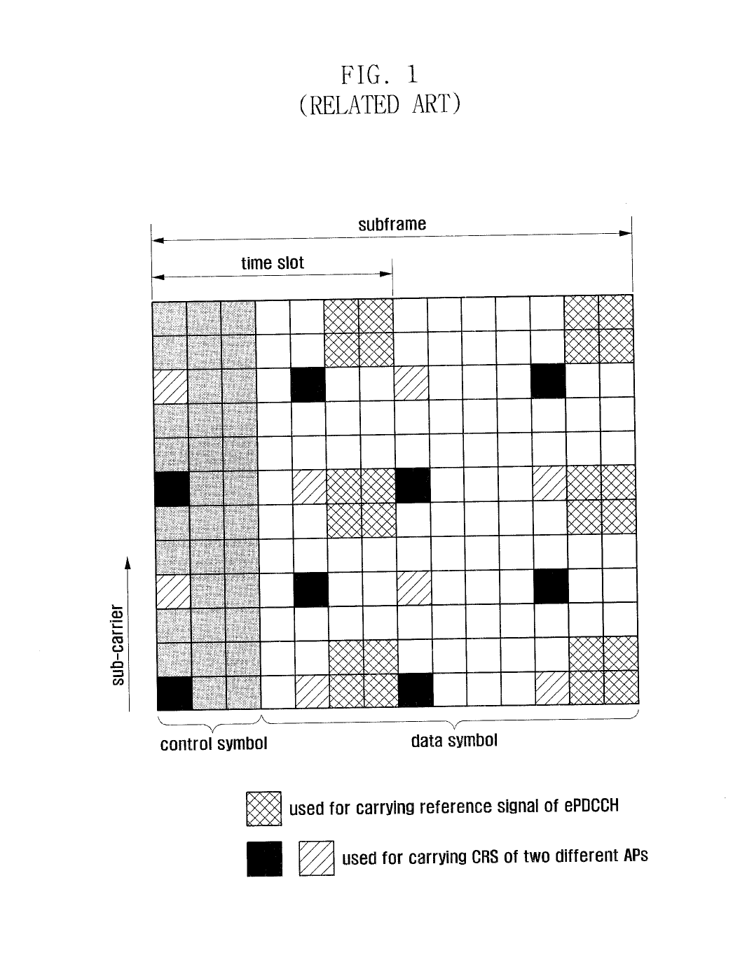

FIG. 2 is a diagram illustrating division of enhanced Resource Element Groups (eREGs) in a Physical Resource Block (PRB) pair according to the related art;

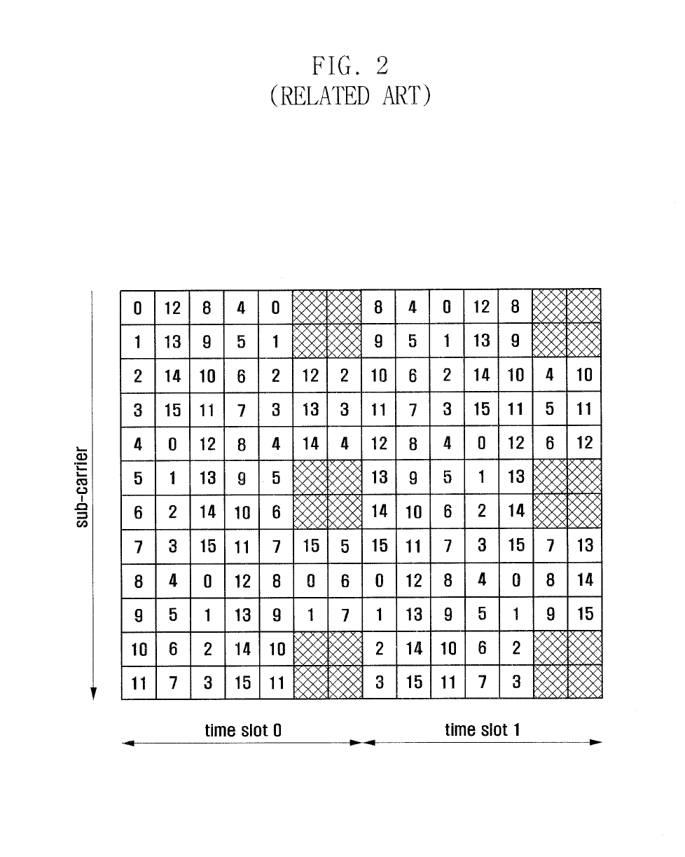

FIG. 3 is a diagram illustrating mapping from Resource Elements (REs) to Antenna Ports (APs) according to a first embodiment of the present disclosure;

FIG. 4 is a diagram illustrating mapping from REs to APs according to a second embodiment of the present disclosure;

FIG. 5 is a diagram illustrating mapping from REs to APs according to a third embodiment of the present disclosure;

FIG. 6 is a first diagram illustrating division of localized enhanced Control Channel Elements (eCCEs) according to an embodiment of the present disclosure;

FIG. 7 is a second diagram illustrating division of localized eCCEs according to an embodiment of the present disclosure;

FIG. 8 is a third diagram illustrating division of localized eCCEs according to an embodiment of the present disclosure;

FIG. 9 is a first diagram illustrating division of distributed eCCEs according to an embodiment of the present disclosure;

FIG. 10 is a second diagram illustrating division of distributed eCCEs according to an embodiment of the present disclosure;

FIG. 11 is a third diagram illustrating division of distributed eCCEs according to an embodiment of the present disclosure;

FIG. 12 is a fourth diagram illustrating division of distributed eCCEs according to an embodiment of the present disclosure;

FIG. 13 is a fifth diagram illustrating division of distributed eCCEs according to an embodiment of the present disclosure;

FIG. 14 is a diagram illustrating a device for configuring spatial diversity of an enhanced Physical Downlink Control Channel (ePDCCH) according to an embodiment of the present disclosure;

FIG. 15 is a diagram illustrating a device for constructing a localized eCCE according to an embodiment of the present disclosure; and

FIG. 16 is a block diagram of a device for constructing a distributed eCCE according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness. E₀(N_{ID}⁽¹⁾)The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In order to make the technical scheme and advantages of the present disclosure clearer, the present disclosure is described in further detail hereinafter with reference to accompanying drawings and examples.

As presented above, for a distributed enhanced Physical Downlink Control CHannel (ePDCCH), link performance is enhanced by a method of spatial diversity. For one ePDCCH, each Resource Element (RE) in one Physical Resource Block (PRB) pair alternately uses one of N_{AP} Antenna Ports (APs) by granularity of one RE, e.g., N_{AP} is equal to 2.

In order to reduce complexity when a User Equipment (UE) demodulates the RE occupied by an ePDCCH candidate, a technical solution for configuring spatial diversity of ePDCCH is provided in the present disclosure. Generally, for the distributed ePDCCH, on the premise of guaranteeing that an RE in each PRB pair of one distributed ePDCCH alternately uses one of the N_{AP} APs by granularity of one RE, each RE in the PRB pair is mapped to a fixed AP. That is, each

RE of an enhanced Resource Element Group (eREG) alternately uses one of the N_{AP} APs by granularity of one RE, and each RE in the PRB pair is mapped to the fixed AP. By use of the method in the present disclosure, when detecting the ePDCCH blindly, the UE only needs to perform the demodulation once for each RE carrying an ePDCCH candidate. Soft bits outputted by the demodulation may be used for a subsequent processing of multiple possible ePDCCH candidates.

Since one PRB pair is divided into N_{eREG} eREGs, e.g., N_{eREG} is equal to 16, and the distributed ePDCCH may only occupy one eREG in one PRB pair, the fixed mapping from the RE to the AP should guarantee that, for each eREG, the RE included in the eREG alternately uses one of the N_{AP} APs by granularity of one RE.

Based on the above, example methods for fixed mapping from the RE to the AP are provided in the present disclosure, which are respectively described as follows.

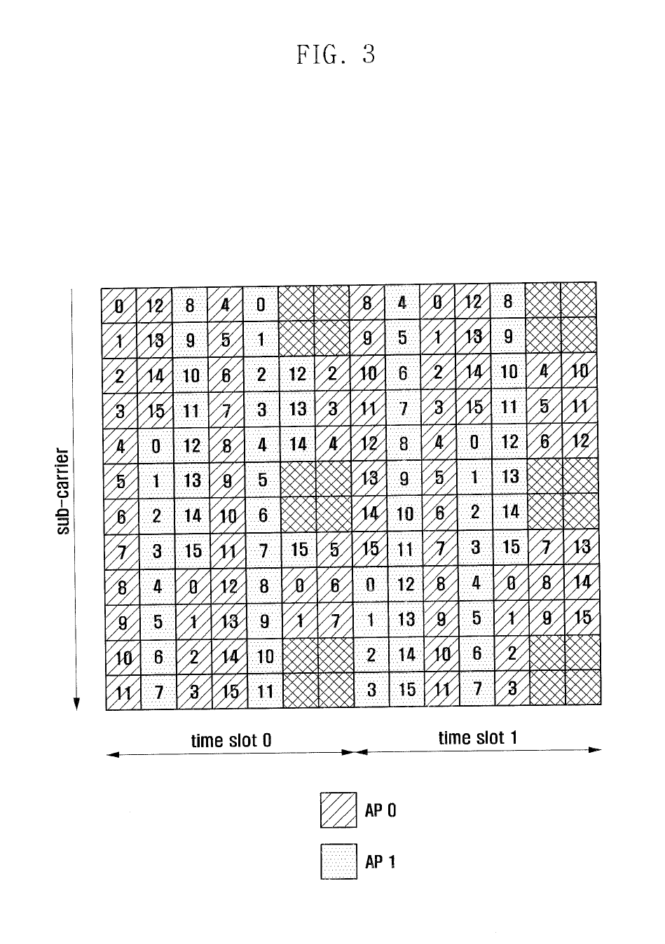

FIG. 3 is a diagram illustrating mapping from Resource Elements (REs) to Antenna Ports (APs) according to a first embodiment of the present disclosure.

Referring to FIG. 3, a first method for the fixed mapping from the RE to the AP provides that each RE in one PRB pair is alternately mapped to one fixed AP according to an index of the RE in the eREG to which the RE belongs. For example, as illustrated in FIG. 3, the k-th RE in the eREG is mapped to the k mod N_{AP}-th AP, wherein k=0,1 . . . N_{eREG}^{RE}−1 and N_{eREG}^{RE} is the total number of the REs included in the eREG.

For N PRB pairs in the ePDCCH set, the same method may be used for mapping from the RE to the AP. For example, by use of this method, the k-th RE in each eREG of each PRB pair is mapped to the k mod N_{AP}-th AP. Since the number of the RE in each PRB pair is 9, e.g., N_{AP} is equal to 2, the number of mappings to APO is one more than the number of mappings to AP1 in each eREG. Thus, when the ePDCCH is constructed by the enhanced Control Channel Element (eCCE) that is composed of multiple eREGs, accordingly, the number of mappings to AP0 is doubled, which is adverse for improving the link performance of the ePDCCH by full use of the spatial diversity.

Therefore, an improved method based the above method is that, for N PRB pairs in the ePDCCH set, different start APs are used for mapping the REs to the APs. For example, the k-th RE of each eREG in the n-th PRB pair is mapped to the (k+n)modN_{AP}-th AP, wherein n=0,1 . . . N−1.

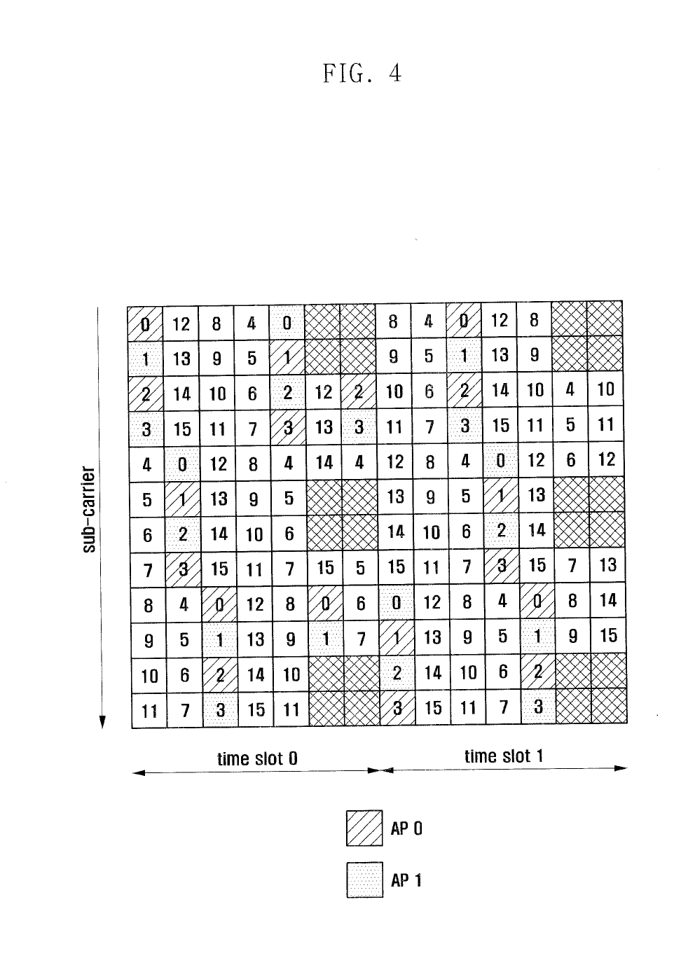

FIG. 4 is a diagram illustrating mapping from REs to APs according to a second embodiment of the present disclosure.

A second method for the fixed mapping from the RE to the AP provides mapping the RE of the eCCE or the ePDCCH to N_{AP} AP as uniformly as possible. In this method, in each PRB pair, different APs are alternately used as the start AP for different eREGs, and each RE is alternately mapped to one fixed AP according to the index of the RE in the eREG to which the RE belongs, to guarantee that when the eCCE in one PRB pair includes multiple eREGs, for all of the REs in these eREGs, the numbers of mapping to N_{AP} APs are equal or close to each other.

Referring to FIG. 4, for example, the k-th RE in the m-th eREG is mapped to the (k+m)mod N_{AP}-th AP, wherein m=0,1 . . . N_{eREG}−1, k=0,1 . . . N_{eREG}^{RE}−1. The method as shown in FIG. 4 may be used in the condition that the eCCE in the PRB pair occupies consecutive eREGs. For N PRB pairs in the ePDCCH set, the same method may be used for mapping the RE to the AP, e.g., by use of this method, and the k-th RE in the m-th eREG is mapped to the (k+m)modN_{AP}-th AP. Alternatively, for N PRB pairs in the ePDCCH set, different methods may be used for mapping the RE to the AP. For example, the k-th RE in the m-th eREG of the n-th PRB pair is mapped to the (k+m+n)modN_{AP}-th AP.

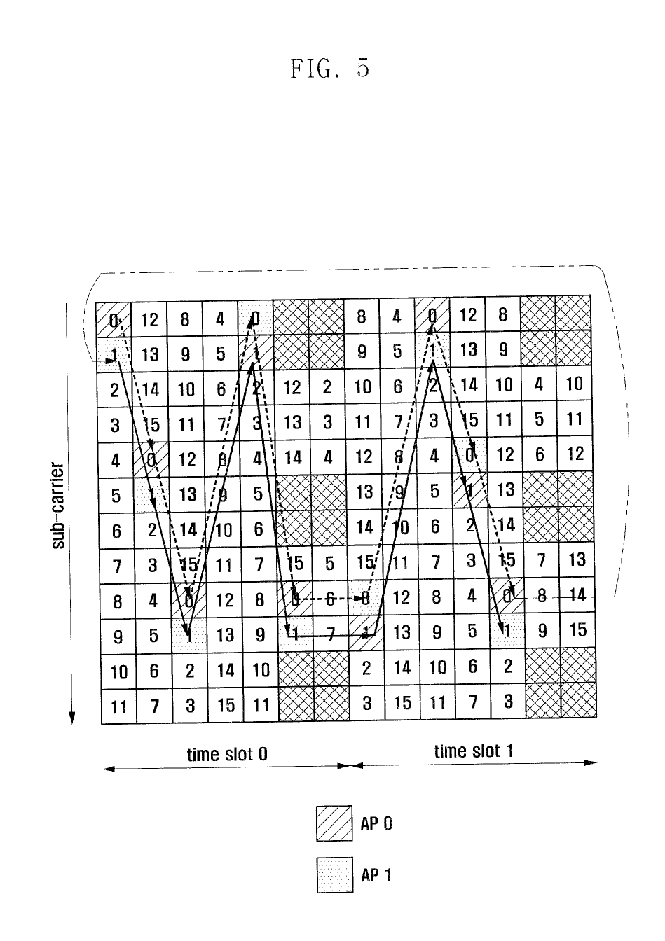

FIG. 5 is a diagram illustrating mapping from REs to APs according to a third embodiment of the present disclosure.

A third method for the fixed mapping from the RE to the AP is provided to map the RE of the eCCE or the ePDCCH to N_{AP} AP as uniformly as possible. First, for each eREG included in one eCCE in each PRB pair, each RE in one eREG is alternately mapped to one fixed AP according to the index of the RE in the eREG, and then each RE in next eREG is alternately mapped to one fixed AP according to the index of the RE in the next eREG. Thus, all of REs in the eCCE are alternately mapped to APs.

Referring to FIG. 5, for example, it is assumed that the eCCE in one PRB pair occupies consecutive eREGs. Thus, 9 REs of a first eREG is alternately mapped to APs starting from APO. Since the number of the REs included in the eREG, i.e., 9 is an odd number, 9 REs in a second eREG are alternately mapped to APs starting from AP1. For N PRB pairs in the ePDCCH set, the same method may be adopted to map the REs to the APs. For example, this method is adapted to mapping the REs to the APs in each PRB pair. Alternatively, in the ePDCCH set, each RE in a first eREG in the (n+1)-th PRB pair closely follows the last RE in the N_{eREG}-th eREG in the n-th PRB pair to perform alternate mapping to APs.

The configuring the spatial diversity of the ePDCCH is in detail described as above in the present disclosure. The constructing of the distributed eCCE and the localized eCCE is described in detail as follows.

The eCCE is obtained by combination of multiple eREGs. Since the numbers of the REs in eREGs divided in one PRB pair that are different from each other. The present disclosure provides that the number of the REs in the eCCEs should be guaranteed to be the same when constructing the eCCE with multiple eREGs. Thus, the link performance of eCCEs may be uniform.

It is considered that OFDM symbol (OS) occupied by a PDCCH in the front of the subframe impacts the ePDCCH. That is, if one OS is used for the PDCCH, the number of the REs in each of the first 12 eREGs is one less than the number of the REs in each of the last 4 eREGs. If 2 OSs are used for the PDCCH, the number of the REs in each of the first 8 eREGs is one less than the number of the REs in each of the last 8 eREGs. If 3 OSs are used for the PDCCH, the number of the REs in each of the first 4 eREGs is one less than the number of the REs in each of the last 12 eREGs.

In addition, the number of the OFDM symbols in a special subframe, i.e., Downlink Pilot Time Slots (DwPTS) is less, and the impact for the number of the REs in the eREG is similar with the PDCCH. Considering the above, the eCCE is constructed with consecutive eREGs as much as possible to avoid that the numbers of the REs constructing the eCCEs are different from each other. If 16 eREGs in one PRB pair are divided into 4 groups, i.e., the eREGs in the groups are respectively indexed as 0˜3, 4˜7, 8˜11, and 12˜15, and when one PRB pair is divided into 4 eCCEs, it is guaranteed that one eCCE respectively occupies the eREG and further occupies only one eREG in each group of the eREG. The number of the eREGs in one PRB pair is referred to as N_{eREG} and each eCCE includes M eREGs, thus, the index of the eREG occupied by the eCCE may be allocated with an interval

$$\frac{{N}_{eREG}}{M} .$$

For example, the index of the eREG included in the p-th localized eCCE is defined in Equation (1):

$$q \cdot \frac{{N}_{eREG}}{M} + p \qquad Equation ( 1 )$$

In Equation (1), q=0,1 . . . M−1, and

$$p = 0 , 1 … \frac{{N}_{eREG}}{M} - 1.$$

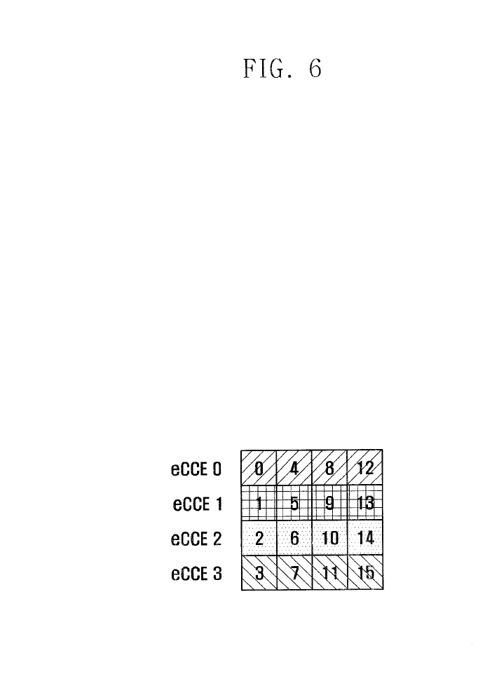

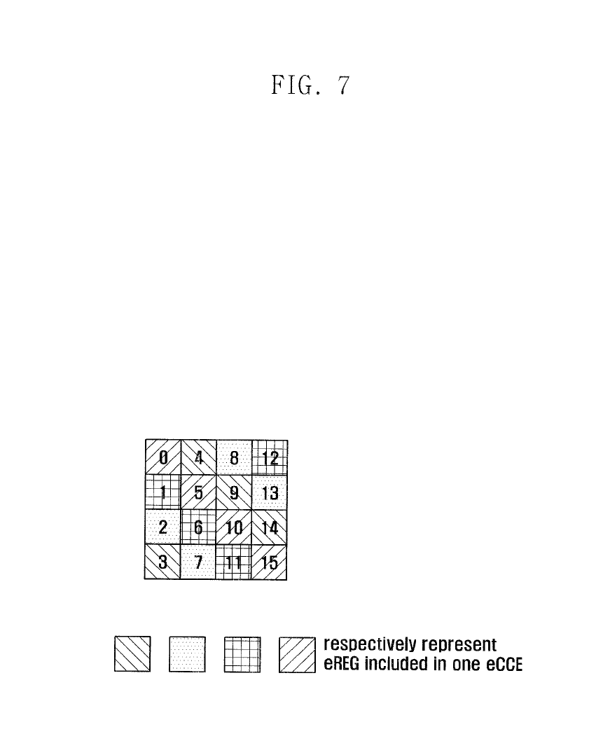

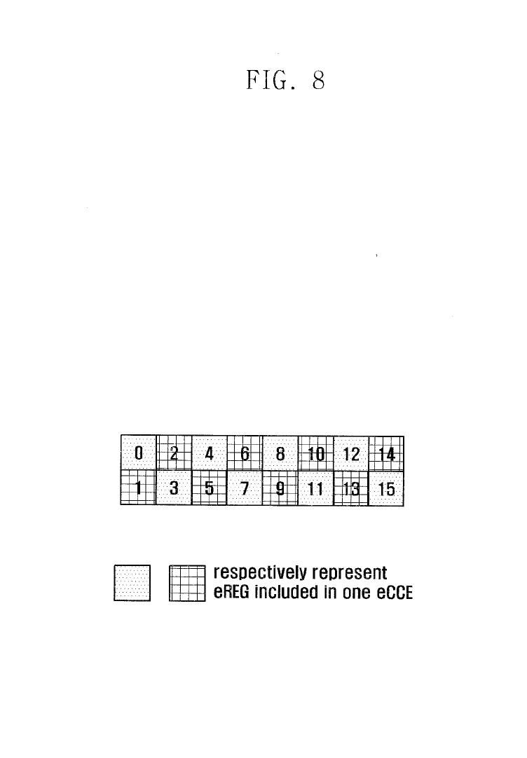

FIG. 6 is a first diagram illustrating division of localized eCCEs according to an embodiment of the present disclosure, FIG. 7 is a second diagram illustrating division of localized eCCEs according to an embodiment of the present disclosure, and FIG. 8 is a third diagram illustrating division of localized eCCEs according to an embodiment of the present disclosure.

It is assumed that M is equal to 4 and, thus, one PRB pair is divided into 4 localized eCCEs, wherein the interval between adjacent eREG in the eCCE is 4.

Referring to FIG. 6, considering that a Channel Quality Indication Reference Signal (CSI-RS) impacts the ePDCCH, the interval of the eREG index corresponding to the REs occupied by two paired CSI-RS ports or 4 CSI-RS ports of one group may be an even number from 2 to 14. Thus, in order to avoid that the REs occupied by the CSI-RS impact one eCCE centrally, preferably all of the intervals of the indexes of the eREGs occupied by one eCCE are not even numbers. Since the interval between indexes of the two adjacent eREGs in the eCCE is 4, the mapping method as shown in FIG. 6 is not an improved method because the PDCCH and the DwPTS impact the ePDCCH as noted above. Based on the method as shown in FIG. 6, an optimized method is that, on the basis of the allocation scheme as shown in FIG. 6, when the eREG indexes in each column are mapped to the eCCE, a cyclic shift is added respectively.

Referring to FIG. 7, the cyclic shift is c when the eREGs in the c-th column are mapped to the eCCE, wherein c=0,1,2,3. Generally, the indexes of the eREGs in the PRB group are divided into M groups and the q-th group sequentially includes the eREGs with the index

$$q \frac{{N}_{eREG}}{M} + g , \\ wherein$$

$$g = 0 , 1 … \frac{{N}_{eREG}}{M} - 1 ,$$

and q=0,1 . . . M−1. And then when the eREGs in the q-th group are mapped to the eCCE, the cyclic shift is added with

$$q mod \frac{{N}_{eREG}}{M} .$$

For example, the index of the eCCE which sequentially occupies each eREG of the q-th group is

$$( g + q ) mod \frac{{N}_{eREG}}{M} , \\ wherein$$

$$g = 0 , 1 … \frac{{N}_{eREG}}{M} - 1 ,$$

q=0,1 . . . M−1. Thus, the index of the eREG included in the p-th localized eCCE may be defined as in Equation (2):

$$q \frac{{N}_{eREG}}{M} + ( q + p ) mod \frac{{N}_{eREG}}{M} \qquad Equation ( 2 )$$

In Equation (2),

$$p = 0 , 1 … \frac{{N}_{eREG}}{M} - 1$$

and q=0,1 . . . M−1.

Referring to FIG. 7, a diagram illustrates that one PRB pair is divided into 4 localized eCCEs, wherein M is assumed as 4.

Referring to FIG. 8, a diagram illustrates that one PRB pair is divided into 2 localized eCCEs, wherein M is assumed as 8.

As presented above, the eCCE is obtained by combination of multiple eREGs. For the localized eCCE, the eREG is mapped into one PRB pair. For the distributed eCCE, the eREG in the eCCE is usually mapped to all of the PRB pairs in the ePDCCH set. It is assumed that the ePDCCH set includes N PRB pairs, and one distributed eCCE occupies M eREGs. Accordingly, a method for constructing the distributed eCCE is that the distributed eCCE occupies

$$⌊ \frac{M}{N} ⌋$$

$$or$$

$$⌈ \frac{M}{N} ⌉$$

eREGs in each PRB pair in the ePDCCH set.

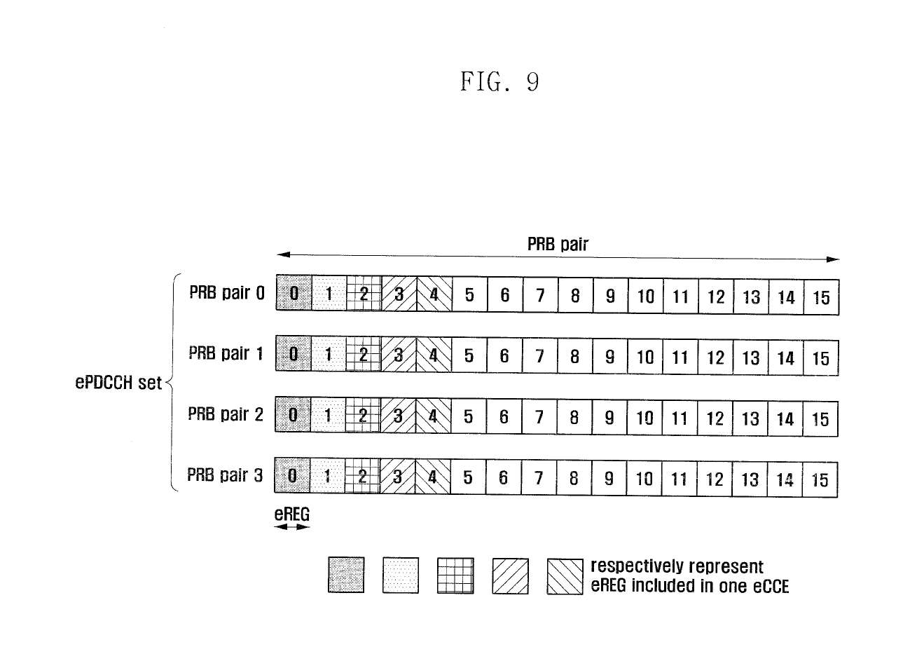

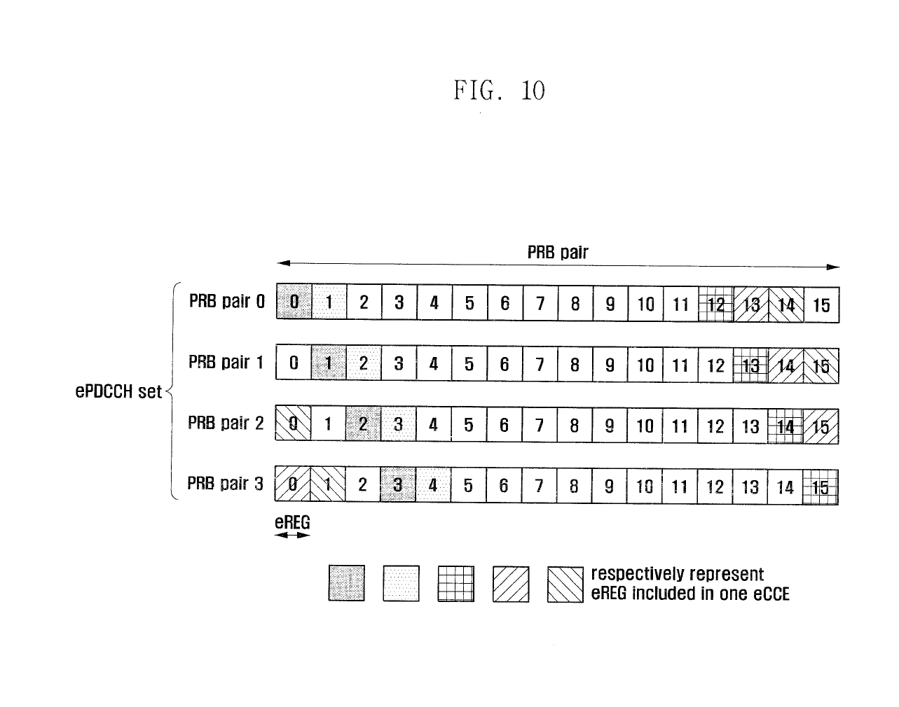

FIG. 9 is a first diagram illustrating division of distributed eCCEs according to an embodiment of the present disclosure and FIG. 10 is a second diagram illustrating division of distributed eCCEs according to an embodiment of the present disclosure.

When M is divisible by N, the distributed eCCE occupies

$$\frac{M}{N}$$

eREGs in each PRB pair. The indexes of the eREGs which are occupied by the distributed eCCE in all of the PRB pairs in the ePDCCH set are the same with each other. For example, the ePDCCH set is divided into

$$\frac{N \cdot {N}_{eREG}}{M}$$

distributed eCCEs, and the p-th distributed eCCE occupies the eREG with index

$$p \cdot \frac{M}{N} + k$$

in all of the PRB pairs in the ePDCCH set, wherein

$$k = 0 , 1 … \frac{M}{N} - 1.$$

Referring to FIG. 9, a diagram illustrating this method is shown, wherein it is assumed that both M and N are equal to 4.

For the method above, the indexes of the eREGs occupied by the distributed eCCE in all of the PRB pairs in the ePDCCH set are the same with each other. While in practice, the REs in eREGs divided in one PRB pair are usually different from each other. Thus, the above-mentioned method that the eREGs which have the same indexes are combined to construct the distributed eCCE that may cause a difference between the number of the REs of the distributed eCCEs to be larger, which is adverse to balance the link performance of each distributed eCCE. The method for constructing the distributed eCCE by combination of the eREGs described as follows provides that the distributed eCCE is mapped to the eREG with a different index in each PRB pair in the ePDCCH and, thus, the number of the REs of the distributed eCCEs are the same or close to each other as possible, which averages the link performance of the distributed eCCEs. Two preferable methods for constructing the distributed eCCE are provided as follows.

A first preferable method for constructing the distributed eCCE presumes that that the ePDCCH set includes N PRB pairs and one distributed eCCE includes M eREGs. First of all, the distributed eCCE is constructed, such that the M eREGs in the eCCE are uniformly distributed into the N PRB pairs, and each PRB pair carries

$$\frac{M}{N}$$

eREGs. And then, the eREG indexes which PRB pair is occupied by other distributed eCCEs in the ePDCCH set by adding a cyclic shift to the index of the eREG, which are occupied by the distributed eCCE.

In more detail, it is assumed that the indexes of the eREGs which are occupied by the distributed eCCE which is distributed first are consecutive in one PRB pair. For example, the index

$$n \frac{M}{N} + q$$

of the eREG in the n-th PRB pair is occupied, wherein

$$q = 0 , 1 … \frac{M}{N} - 1 ,$$

thus, the p-th distributed eCCE occupies the eREG with the index

$$( n \cdot \frac{M}{N} + q + p \frac{M}{N} ) mod {N}_{REG}$$

in the n-th PRB pair in the ePDCCH set, wherein

$$q = 0 , 1 … \frac{M}{N} - 1 , and p = 0 , 1 … \frac{N \cdot {N}_{REG}}{M} - 1.$$

It is assumed that the intervals between the

$$\frac{M}{N}$$

eREGs into which the distributed eCCE is mapped in the ePDCCH set are the integer multiple of

$$\frac{N \cdot {N}_{eREG}}{M} .$$

For example, the eREG with the index

$$n + q \cdot \frac{N \cdot {N}_{eREG}}{M}$$

is occupied in the n-th PRB pair, wherein

$$q = 0 , 1 … \frac{M}{N} - 1.$$

Thus, the p-th distributed eCCE occupies the eREG with the index

$$( n + q \cdot \frac{N \cdot {N}_{eREG}}{M} + p ) mod {N}_{REG}$$

in the n-th PRB pair in the ePDCCH set, wherein

$$q = 0 , 1 … \frac{M}{N} - 1 , and p = 0 , 1 … \frac{N \cdot {N}_{REG}}{M} - 1.$$

Referring to FIG. 10. a diagram illustrating this method is shown, wherein it is assumed that both M and N are equal to 4.

A second preferable method for constructing the distributed eCCE follows. The main idea of the method is that the methods used to construct the eCCE by the eREG are unified for a distributed ePDCCH set including N PRB pairs and a localized ePDCCH set including N PRB pairs. The benefit of this treatment is to cause the number of the REs included in the distributed eCCE and localized eCCE to be equal.

It is assumed that the localized eCCE includes M eREGs, and the set including the eREG indexes is K. Accordingly, eREG indexes in the set K are respectively referred to as k₁, wherein i=0,1 . . . M−1. In the present disclosure, the method for constructing set K is not limited, and the eREG indexes in the set K may be continuous or non-continuous. The method for constructing the distributed eCCE provides that M eREGs, which are occupied by the distributed eCCE, are distributed into N PRB pairs in the ePDCCH set as uniformly as possible. Each PRB pair carries

$$⌊ \frac{M}{N} ⌋ or ⌈ \frac{M}{N} ⌉$$

eREGs. When M is divisible by N,

$$\frac{M}{N}$$

eREGs are occupied in each PRB pair and the indexes of the M eREGs occupied by the distributed eCCE still belong to set K. N distributed eCCEs may be obtained according to the same localized eCCE. Since one PRB pair may be divided into

$$\frac{{N}_{REG}}{M}$$

localized eCCEs, the total number of the distributed eCCEs into which the ePDCCH set is divided is

$$N \cdot \frac{{N}_{REG}}{M} .$$

The preferable example of obtaining N distributed eCCEs corresponding to one localized eCCE is provided as follows. If M is greater than N, the distributed eCCE occupies

$$\frac{M}{N}$$

eREGs in one PRB pair. If it is assumed that the indexes i in the set K corresponding to the indexes of the

$$\frac{M}{N}$$

eREGs in the same PRB pair are consecutive, the indexes of the eREGs in the n-th PRB pair of the ePDCCH set occupied by the p-th distributed eCCE are

$${k}_{( ( n \cdot \frac{M}{N} + q + p \frac{M}{N} ) mod M )} ,$$

wherein p=0,1 . . . N−1 and n=0,1 . . . N−1. If it is assumed that the interval between the indexes i in the set K corresponding to the indexes of the

$$\frac{M}{N}$$

eREGs in the same PRB pair is N, the index of the eREGs in the n-th PRB pair of the ePDCCH set occupied by the p-th distributed eCCE are k_{((n+q·N+p)modM)}, wherein p=0,1 . . . N−1, n=0,1 . . . N−1, and

$$q = 0 , 1 … \frac{M}{N} - 1.$$

If M is equal to N, the indexes of the eREGs in the n-th PRB pair of the ePDCCH set occupied by the p-th distributed eCCE are k_{((n+p)mod M)}, wherein p=0,1 . . . M−1, and n=0,1 . . . M−1.

If M is less than N, N PRB pairs of the ePDCCH set need to be divided to several subsets equally. And each subset includes M PRB pairs so that each subset can map M distributed eCCEs. The p-th distributed eCCE occupies the eREGs with the indexes k_{((n+p)mod M)} in the n-th PRB pair in the ePDCCH set, wherein p=0,1 . . . M−1, and n=0,1 . . . M−1.

The above-mentioned method is further instructed according to several examples as follows.

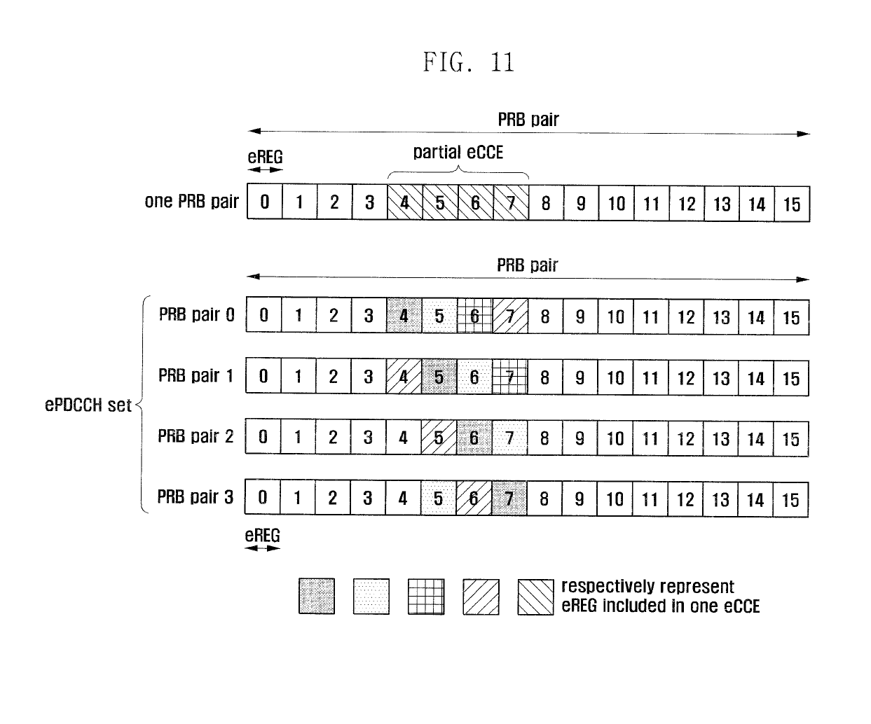

FIG. 11 is a third diagram illustrating division of distributed eCCEs according to an embodiment of the present disclosure.

Referring to FIG. 11, it is assumed that both M and N are equal to 4, and the distributed eCCE includes the eREGs with indexes 4, 5, 6 and 7. It should be noted that the present disclosure is not limited to the localized eCCE that must occupy consecutive eREG indexes. Here, the condition of the indexes of the eREGs occupied by four distributed eCCEs is as follows: one distributed eCCE occupies the eREGs with indexes 4, 5, 6, 7 in PRB pairs 0, 1, 2, 3; one distributed eCCE occupies the eREGs with indexes 7, 4, 5, 6 in PRB pairs 0, 1, 2, 3; one distributed eCCE occupies the eREGs with indexes 6, 7, 4, 5 in PRB pairs 0, 1, 2, 3; and one distributed eCCE occupies the eREGs with indexes 5, 6, 7, 4 in PRB pairs 0, 1, 2, 3.

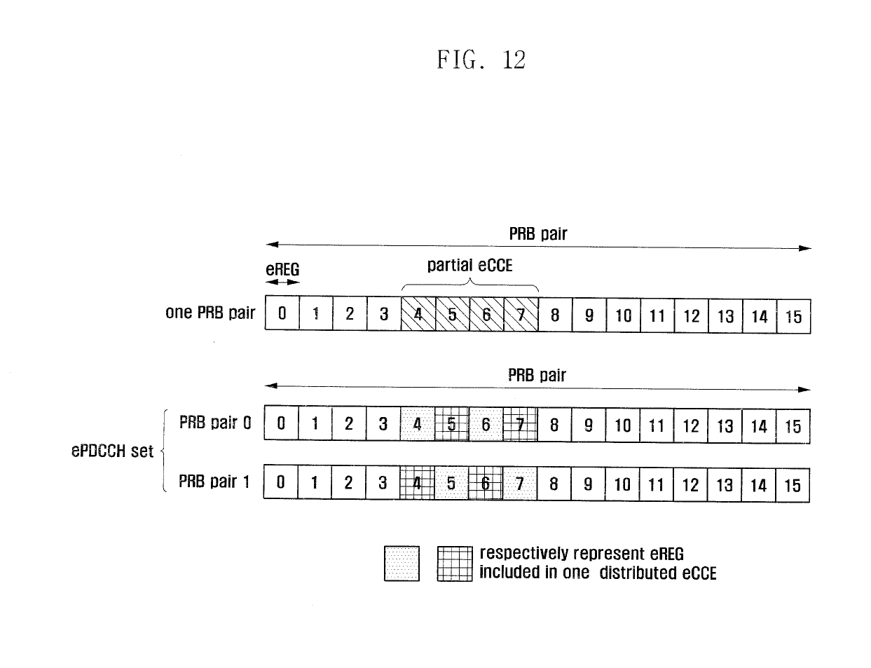

FIG. 12 is a fourth diagram illustrating division of distributed eCCEs according to an embodiment of the present disclosure.

Referring to FIG. 12, it is assumed that M is equal to 4, N is equal to 2, and one localized eCCE includes the eREG with indexes 4, 5, 6 and 7. It should be noted that the present disclosure is not limited to the localized eCCE that occupies eREGs with consecutive indexes. Since M is twice as large as N, one localized eCCE needs to occupy two eREGs in one PRB pair. In more detail, one localized eCCE occupies the eREGs with indexes 4, 6 in PRB pair 0, and occupies the eREGs with indexes 5, 7 in PRB pair 1. Another distributed eCCE occupies the eREGs with indexes 5, 7 in PRB pair 0, and occupies the eREGs with indexes 4, 6 in PRB pair 1.

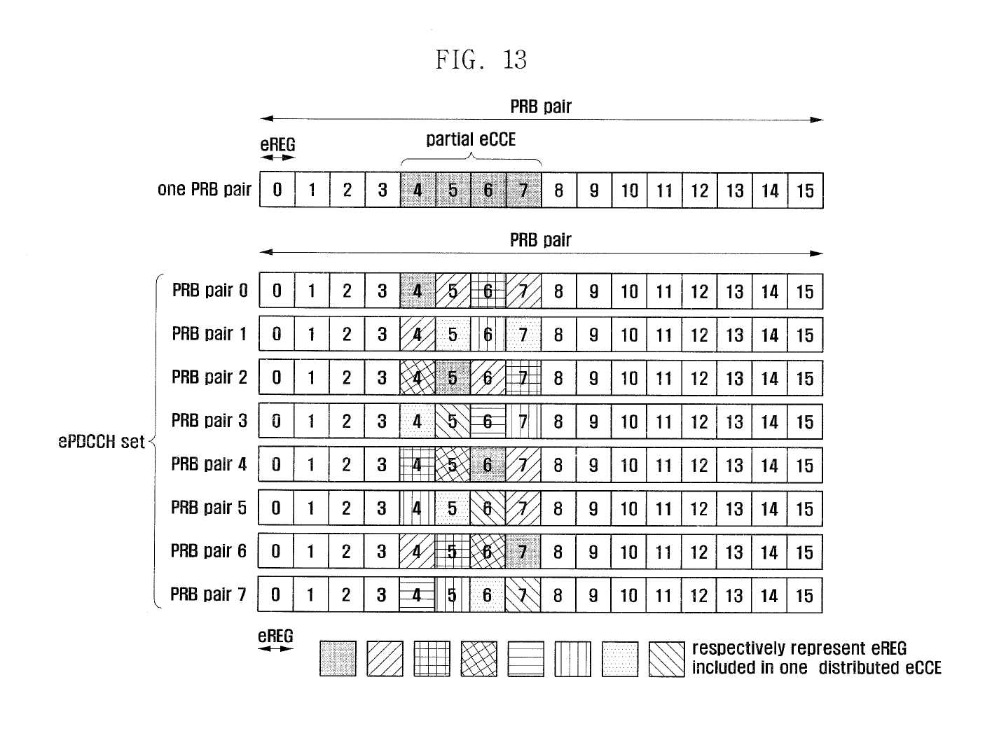

FIG. 13 is a fifth diagram illustrating division of distributed eCCEs according to an embodiment of the present disclosure.

Referring to FIG. 13, it is assumed that M is equal to 4, N is equal to 8, and the localized eCCE occupies the eREG with indexes 4, 5, 6 and 7. It should be noted that the present disclosure is not limited to the localized eCCE that occupies eREGs with consecutive indexes. Since M is twice as large as N, N PRB pairs need to be divided into 2 subsets first. For example, PRB pairs 0, 2, 4, 6 construct one subset, and PRB pairs 1, 3, 5, 7 construct one subset. And then, M distributed eCCEs are defined in each subset, wherein M is equal to 4. In more detail, for the subset including PRB pairs 0, 2, 4, 6, the condition of the eREG indexes occupied by the four eCCEs is as follows: one distributed eCCE sequentially occupies eREGs with indexes 4, 5, 6, 7 in PRB pairs 0, 2, 4, 6; one distributed eCCE sequentially occupies eREGs with indexes 7, 4, 5, 6 in PRB pairs 0, 2, 4, 6; one distributed eCCE sequentially occupies eREGs with indexes 6, 7, 4, 5 in PRB pairs 0, 2, 4, 6; and one distributed eCCE sequentially occupies eREGs with indexes 5, 6, 7, 4 in PRB pairs 0, 2, 4, 6.

For the subset including PRB pairs 1, 3, 5, 7, the condition of the eREG indexes occupied by the four eCCEs is as follows: one distributed eCCE occupies sequentially the eREGs with indexes 4, 5, 6, 7 in PRB pairs 1, 3, 5, 7; one distributed eCCE occupies sequentially the eREGs with indexes 7, 4, 5, 6 in PRB pairs 1, 3, 5, 7; one distributed eCCE occupies sequentially the eREGs with indexes 6, 7, 4, 5 in PRB pairs 1, 3, 5, 7; and one distributed eCCE occupies sequentially the eREGs with indexes 5, 6, 7, 4 in PRB pairs 1, 3, 5, 7.

Devices corresponding to above-mentioned methods are provided in the present disclosure, which are described respectively as follows.

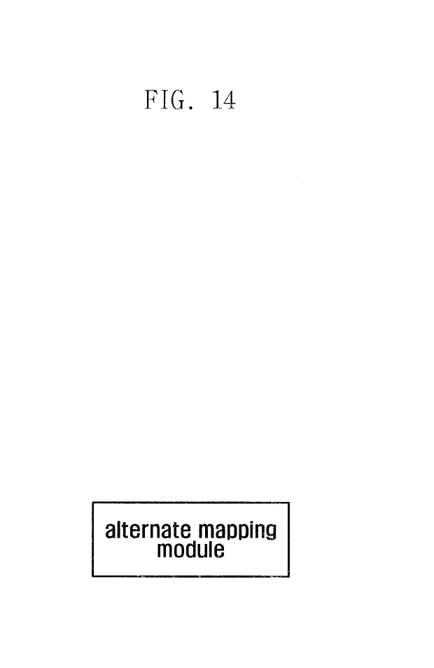

FIG. 14 is a diagram illustrating a device for configuring spatial diversity of an ePDCCH according to an embodiment of the present disclosure.

Referring to FIG. 14, the device includes an alternate mapping module adapted to cause a RE of each eREG alternately use one of N_{AP} APs by the granularity of one RE, and map each RE to a fixed AP in the PRB pair, wherein N_{AP} is larger than or equal to 2.

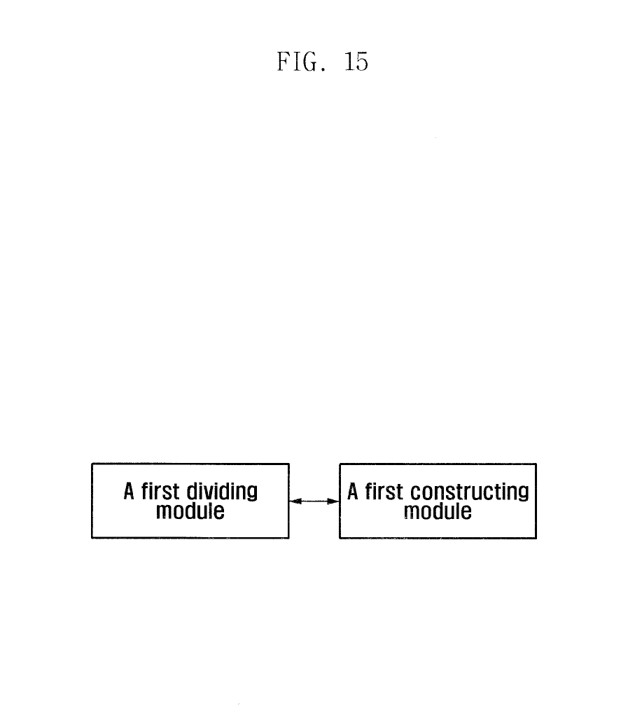

FIG. 15 is a diagram illustrating a structure of a device for constructing a localized eCCE according to an embodiment of the present disclosure.

Referring to FIG. 15, the device includes a first dividing module and a first constructing module, wherein the first dividing module is adapted to divide each PRB into N_{eREG} eREGs.

The first constructing module is adapted to construct the localized eCCE by combining the REGs according to the number of the OFDM symbols occupied by a PDCCH, the number of DwPTS symbols, and the locations of CSI-RSs, such that the number of the REs of constructed localized eCCEs are equal or close to each other.

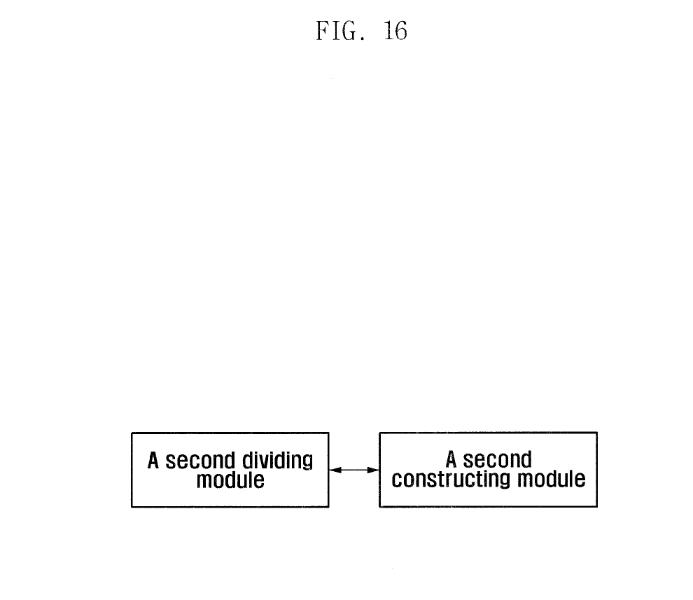

FIG. 16 is a block diagram of a device for constructing a distributed eCCE according to an embodiment of the present disclosure.

Referring to FIG. 16, the device includes a second dividing module and a second constructing module, wherein the second dividing module is adapted to divide each PRB pair into N_{eREG} eREGs and the second constructing module is adapted to cause each localized eCCE in an ePDCCH set occupy

$$\frac{M}{N}$$

eREGs and map each distributed eCCEs into an eREG with a different index in each PRB pair of the ePDCCH set, wherein M is the number of the REs included in the distributed eCCE, and N is the number of the PRB pairs included in the ePDCCH set.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for configuring spatial diversity of an enhanced Physical Downlink Control CHannel (ePDCCH), the method comprising:
alternately using, by each Resource Element (RE) in an enhanced Resource Element Group (eREG), one of N_{AP} Antenna Ports (AP) by granularity of one RE; and
mapping each RE in a Physical Resource Block (PRB) pair to a fixed AP.

2. The method according to claim 1, wherein the mapping of each RE in a PRB pair to a fixed AP comprises:
alternately mapping each RE in the PRB pair to one fixed AP according to an index of the RE in the eREG to which the RE belongs, wherein each PRB pair in an ePDCCH set alternately use a different AP as a start AP.

3. The method according to claim 1, wherein the mapping of each RE in a PRB pair to one fixed AP comprises:
alternately mapping each RE in the PRB pair to one fixed AP according to a RE index of the RE in the eREG to which the RE belongs, wherein different eREGs in the PRB pair alternately use different APs as start APs.

4. The method according to claim 1, wherein the mapping of each RE in a PRB pair to a fixed AP comprises for each eREG included in an eCCE comprises:
for each eREG included in one eCCE, mapping alternately each RE in one eREG to one fixed AP according to the index of the RE in the eREG; and
mapping alternately each RE in next one eREG to one fixed AP according to the index of the RE in the eREG, wherein all of REs in the eCCE is alternately mapped to APs.

5. A method for constructing a localized enhanced Control Channel Element (eCCE), the method comprising:
dividing each Physical Resource Block (PRB) pair into N_{eREG} enhanced Resource Element Groups (eREG); and
constructing the localized eCCE by combination of eREGs according to a number of Orthogonal Frequency Division Multiple Access (OFDM) symbols occupied by a Physical Downlink Control CHannel (PDCCH), a number of symbols of Downlink Pilot Time Slots (DwPTS), and locations of channel quality Indication Reference Signals (CSI-RS), such that a number of Resource Elements (REs) of the constructed eCCEs are equal or close to each other.

6. The method according to claim 5, wherein the constructing of the localized eCCE by combination of eREGs comprises:
constructing the p-th localized eREG by combining the eREGs with the indexes
$$q \cdot \frac{{N}_{e REG}}{M} + p ,$$
wherein, q=0,1 . . . M−1, M is the number of the REs included in the localized eCCE, and
$$p = 0 , 1 … \frac{{N}_{eREG}}{M} - 1.$$

7. The method according to claim 5, wherein the constructing of the localized eCCE by combination of eREGs comprises:
constructing the p-th localized eREG by combination of the eREGs with the indexes
$$q \frac{{N}_{eREG}}{M} + ( q + p ) mod \frac{{N}_{eREG}}{M} ,$$
wherein, q=0,1 . . . M−1, M is the number of the REs included in the localized eCCE; and
$$p = 0 , 1 … \frac{{N}_{eREG}}{M} - 1.$$

8. A method for constructing a distributed enhanced Control Channel Element (eCCE), the method comprising:
dividing each Physical Resource Block (PRB) pair into N_{eREG} enhanced Resource Element Groups (eREG); and
occupying, by each distributed eCCE,
$$\frac{M}{N}$$
eREGs in each PRB pair in an enhanced Physical Downlink Control CHannel (ePDCCH) set and mapping each distributed eCCE to the eREG with a different index in each PRB pair in the ePDCCH set,
wherein, M is a number of Resource Elements (REs) included in the distributed eCCE, and N is a number of PRB pairs in the ePDCCH set.

9. The method according to claim 8, wherein the mapping of each distributed eCCE to the eREG with a different index in each PRB pair in the ePDCCH set comprises:
constructing a distributed eCCE, wherein M eREGs is uniformly distributed to N PRB pairs in the ePDCCH set and each PRB pair carries
$$\frac{M}{N}$$
eREGs; and
obtaining the index of the eREG to which other distributed eCCE is mapped in the ePDCCH set by adding a cyclic shift to the index of the eREG occupied by the distributed eCCE.

10. The method according to claim 8, wherein the mapping of each distributed eCCE to the eREG with a different index in each PRB pair in the ePDCCH set comprises mapping each distributed eCCE to M eREGs with indexes in set K, wherein set K is a set of indexes of eREGs occupied by the localized eCCE in one PRB pair and each index of each eREG in set K is referred to as kᵢ, wherein i=0,1 . . . M−1.

11. The method according to claim 10, further comprising:
constructing the p-th distributed eCCE by combination of the eREGs with the indexes
$${k}_{( ( n \cdot \frac{M}{N} + q + p \frac{M}{N} ) mod M )}$$
in the n-th PRB pair of the ePDCCH set, when M is larger than N,
wherein, p=0,1 . . . N−1, n=0,1 . . . N−1, and
$$q = 0 , 1 … \frac{M}{N} - 1.$$

12. The method according to claim 10, further comprising:
constructing the p-th distributed eCCE by combination of the eREGs with the indexes k_{((n+q·N+p)modM)} in the n-th PRB pair of the ePDCCH set, when M is larger than N,
wherein, p=0,1 . . . N−1, n=0,1 . . . N−1, and
$$q = 0 , 1 … \frac{M}{N} - 1.$$

13. The method according to claim 10, further comprising:
constructing the p-th distributed eCCE by combination of the eREGs with the indexes k_{((n+p)modM)} in the n-th PRB pair of the ePDCCH set, when M is equal to N,
wherein, p=0,1 . . . N−1 and n=0,1 . . . N−1.

14. A device for constructing spatial diversity of an enhanced Physical Downlink Control CHannel (ePDCCH), the device comprising:
an alternate mapping module,
wherein, the alternate mapping module is adapted to cause a Resource Element (RE) of each enhanced Resource Element Group (eREG) alternately use one of N_{AP} APs by a granularity of one RE to map each RE to a fixed Antenna Ports (AP) in a Physical Resource Block (PRB) pair, and
wherein, N_{AP} is larger than or equal to 2.

15. A device for constructing a localized enhanced Control Channel Element (eCCE), the device comprising:
a first dividing module; and
a first constructing module, wherein, the first dividing module is adapted to divide each Physical Resource Block (PRB) pair into N_{eREG} enhanced Resource Element Groups (eREG); and
wherein, the first constructing module is adapted to construct the localized eCCE by combination of the REGs according to a number of Orthogonal Frequency Division Multiplexing (OFDM) symbols occupied by a Physical Downlink Control CHannel (PDCCH), a number of Downlink Pilot Time Slots (DwPTS) symbols, and locations of channel quality Indication Reference Signals (CSI-RS), such that a number of the Resource Element (REs) of constructed localized eCCEs are equal or close to each other.

16. A device for constructing a distributed enhanced Control Channel Element (eCCE), the device comprising:
a second dividing module; and
a second constructing module, wherein, the second dividing module is adapted to divide each Physical Resource Block (PRB) pair into N_{eREG} enhanced Resource Element Groups (eREG); and wherein, the second constructing module is adapted to cause each localized eCCE in an enhanced Physical Downlink Control CHannel (ePDCCH) set occupy
$$\frac{M}{N}$$
eREGs and map each distributed eCCEs to a eREG with a different index in each PRB pair of the ePDCCH set, wherein M is a number of the REs included in the distributed eCCE and N is a number of the PRB pairs included in the ePDCCH set.
